(19) United States
(12) Patent Application Publication
(10) Pub. No.: US 2025/0115102 A1
(43) Pub. Date: Apr. 10, 2025

(54) VEHICLE DOOR INCLUDING A PLASTIC FILM SEAL AND A METHOD OF ASSEMBLING THE SAME

(71) Applicants: HYUNDAI MOTOR COMPANY, Seoul (KR); KIA CORPORATION, Seoul (KR)

(72) Inventors: Ho-Young Yoon, Anyang-si (KR); Je-Sun Han, Anyang-si (KR); Jae-Eun Chang, Gwangmyeong-si (KR)

(73) Assignees: HYUNDAI MOTOR COMPANY, Seoul (KR); KIA CORPORATION, Seoul (KR)

(21) Appl. No.: 18/665,084

(22) Filed: May 15, 2024

(30) Foreign Application Priority Data
Oct. 6, 2023 (KR) 10-2023-0133782

(51) Int. Cl. B60J 5/04; B60R 13/02

(52) U.S. Cl. CPC B60J 5/0418; B60J 5/0413; B60J 5/0469; B60R 13/0243

(57) ABSTRACT

Provided are a vehicle door including a plastic film seal and a method of assembling the same. The plastic film seal is attached to an inner panel of a vehicle door between the inner panel and a door trim to improve watertight performance and, when the door trim is removed, improve the outer appearance. The vehicle door includes an outer panel, an inner panel provided inside of the outer panel, a door trim attached to and finishing the inner panel, and a plastic film seal provided between the inner panel and the door trim.

### CROSS-REFERENCE TO RELATED APPLICATION

This application claims priority to Korean Patent Application No. 10-2023-0133782, filed on Oct. 6, 2023, which is incorporated herein by reference in its entirety.

### BACKGROUND

### Field

The present disclosure relates to a vehicle door including a plastic film seal and a method of assembling the same.

### Description of Related Art

A vehicle door is typically made of metal panels, and various devices are disposed therein.

For example, devices such as a regulator raising and lowering a door glass mounted on the door, a speaker, and the like are disposed at the door. Such the devices are assembled together into a single module before being disposed at the door, or respective devices are directly disposed at the door. In particular, the regulator is divided into a modular regulator in which the components constituting the regulator are formed into a single module and a non-modular regulator in which the components constituting the regulator are individually and directly disposed at the door.

Compared to the modular regulator, the non-modular regulator has problems in that the non-modular regulator has a bad appearance and the watertight performance thereof deteriorates when the door trim is separated from the door. The door trim is assembled to the door after the regulator is mounted on the door. Before the door trim fitting or when the door trim is separated from the door for maintenance, individual components of the non-modular regulator are exposed outside and through-holes through which the individual components are mounted to the door are also exposed, thereby degrading the appearance of the door. In addition, a plastic film is attached to an inner panel of the door before the door trim is assembled to the door in order to provide a watertight seal. Here, the plastic film has a simple planar shape. The peripheral portions of the plastic film are cut conformingly to a portion of the inner panel to which the plastic film is to be attached, and then the plastic film is attached to the inner panel of the door, thereby covering the respective devices mounted on the door. Since the plastic film has a simple planar shape, some peripheral portions of the plastic film may not be tightly attached to the inner panel due to a portion of the devices protruding toward a compartment of the vehicle, thereby failing to provide a watertight seal. In other words, in a case that there is a protruded portion toward the compartment of vehicle, for example, the inner panel is convex inward or a wiring is disposed, some peripheral portions of the plastic film may not be attached to the inner panel or may be separated therefrom after being attached, thereby failing to provide a watertight seal.

In addition, when applying plastic film to the inner panel, it is difficult to set an attachment position of the plastic film on the inner panel, so the attachment position of the plastic film may not be uniform, thereby causing deterioration in watertight performance.

The statements in this BACKGROUND section merely provide background information related to the present disclosure and may not constitute prior art.

### SUMMARY

The present disclosure provides a vehicle door including a plastic film seal and a method of assembling the same. The plastic film seal may have a three-dimensional (3D) shape conforming to an internal shape of the vehicle door, and when attaching the plastic film seal to the vehicle door, it may allow a reference position of the plastic film seal to be easily set and improve watertight performance.

In an aspect of the present disclosure, a vehicle door includes: an outer panel; an inner panel provided inside of the outer panel; a door trim attached to the inner panel and finishing the inner panel; and a plastic film seal provided between the inner panel and the door trim.

The plastic film seal may be attached to the inner panel by an adhesive tape.

The inner panel may include a tape-receiving groove configured to receive or accommodate the adhesive tape.

The tape-receiving groove may form a closed curve surrounding a predetermined area on the inner panel.

The plastic film seal may include an adhesion guide configured to receive the adhesive tape.

The adhesion guide may form a closed curve extending along a periphery of the plastic film seal.

The inner panel may include a mounting reference protrusion protruding into a compartment of the vehicle, and the plastic film seal may include a mounting reference hole allowing the mounting reference protrusion to penetrate therethrough.

The plastic film seal may include reinforcement ribs in a form of a grid.

The reinforcement ribs may be provided at a predetermined position and in a predetermined area on the plastic film seal.

The plastic film seal may include a wiring receptacle that is convex toward the door trim and is configured to receive the wiring.

The plastic film seal may include a wiring slit allowing the wiring to extend therethrough.

The plastic film seal may include a first drain guide protruding toward an outside of the vehicle, with the width thereof increasing in a downward direction so that moisture flows through the first drain guide.

The plastic film seal may include a second drain guide provided below the first drain guide and configured to guide moisture to flow downward for discharge.

The plastic film seal may be made of a thermoplastic material, e.g., polyethylene.

The plastic film seal may be formed by vacuum molding a plastic film.

The plastic film seal may be formed in a shape conforming to a shape of the inner panel.

The plastic film seal may include an embossed surface.

In another aspect of the present disclosure, a method of assembling a vehicle door including a plastic film seal comprises: attaching an adhesive tape to a tape-receiving groove provided in an inner panel; positioning a plastic film seal at a predetermined position of the inner panel; attaching the plastic film seal to the adhesive tape by pressing the plastic film seal along a portion to which the adhesive tape is attached; and mounting a door trim on the inner panel.

In positioning the plastic film seal, the plastic film seal may be positioned on the inner panel by fitting or aligning a mounting reference hole provided in the plastic film seal to a mounting reference protrusion provided on the inner panel.

In the vehicle door including a plastic film seal and a method of assembling the same having the above-described configuration according to the present disclosure, the plastic film seal may not be wrinkled or a peripheral portion thereof may not be separated from the inner panel, so that watertight performance may be improved.

In addition, when attaching the plastic film seal to the inner panel, an initial position of the plastic seal may be easily set.

Furthermore, when the door trim is separated, the inner panel side appearance of the door may be improved.

Further areas of applicability should become apparent from the description provided herein. It should be understood that the description and specific embodiments are intended for purposes of illustration only and are not intended to limit the scope of the present disclosure.

### BRIEF DESCRIPTION OF THE DRAWINGS

FIG. 1 is an exploded perspective view illustrating a vehicle door including a plastic film seal according to an embodiment of the present disclosure.

FIG. 2 is a plan view illustrating an inner panel in the vehicle door including a plastic film seal according to an embodiment of the present disclosure.

FIG. 3 is a plan view illustrating the plastic film seal in the vehicle door according to an embodiment of the present disclosure.

FIG. 4 is a cross-sectional diagram taken along line I-I in FIG. 3.

FIG. 5 is a cross-sectional diagram taken along line II-II in FIG. 3.

FIG. 6 is a perspective diagram illustrating a moisture discharge passage where the moisture flows in a direction along arrows in the plastic film seal according to an embodiment of the present disclosure.

FIGS. 7 and 8 are enlarged perspective diagrams illustrating portions where a wiring extends through a wiring slit in the vehicle door including a plastic film seal according to an embodiment of the present disclosure.

FIG. 9 is a flowchart illustrating a method of assembling the vehicle door including a plastic film seal according to an embodiment of the present disclosure.

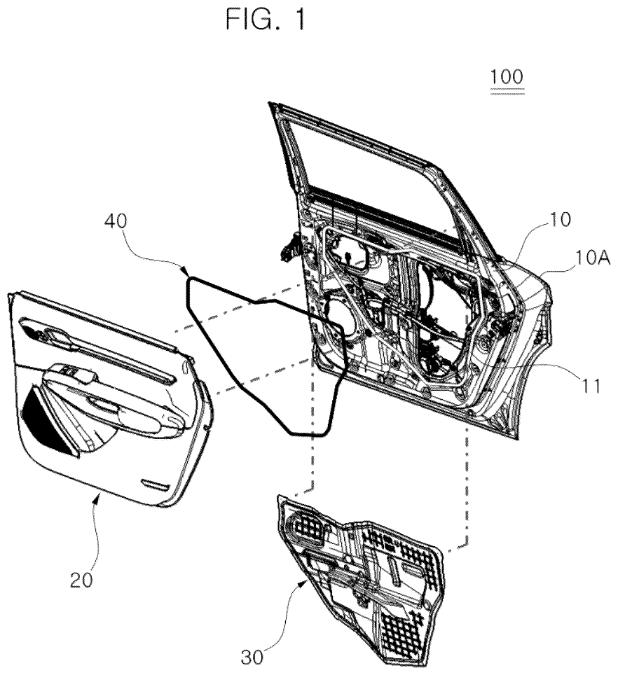

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

When a component, device, element, or the like of the present disclosure is described as having a purpose or performing an operation, function, or the like, the component, device, or element should be considered herein as being “configured to” meet that purpose or to perform that operation or function.

Hereinafter, a vehicle door including a plastic film seal and a method of assembling the same according to the present disclosure are described in detail with reference to the accompanying drawings.

According to an embodiment of the present disclosure, a vehicle door 100 may include: an inner panel 10 provided inside of an outer panel 10A of the vehicle door 100, a door trim 20 attached to the inner panel 10 and finishing the inner panel 10, and a plastic film seal 30 provided between the inner panel 10 and the door trim 20. In particular, the door trim 20 completes the inner panel 10, making it look more aesthetically pleasing or functionally complete.

The vehicle door 100 may be typically fabricated from a plurality of panels including the inner panel 10 and the outer panel 10A.

The inner panel 10 may be located at an innermost position in a widthwise direction of the vehicle among panels of the vehicle door 100.

The inner panel 10 may have a through-hole allowing a variety of devices such as a regulator and a speaker to be disposed therein or various cables (or wiring) to extend therethrough. In addition, a fastening-hole allowing the door trim 20 to be mounted to the inner panel 10 may be provided.

A tape-receiving groove 11 for accommodating an adhesive tape 40 to mount the plastic film seal 30 may be provided and formed in the inner panel 10. The cross-section of the tape-receiving groove 11 may have a predetermined depth in the outward direction of the vehicle. The tape-receiving groove 11 may be provided in the inner panel 10 in the form of a closed curve. The tape-receiving groove 11 may be formed in a predetermined area of the inner panel 10, such as an area requiring watertightness.

The door trim 20 may be attached to the inner panel 10. The door trim 20 may be a portion of the vehicle door 100 that is exposed into the vehicle (i.e., an interior of the vehicle) and finishes the inner panel 10.

The adhesive tape 40 may be inserted into the tape-receiving groove 11. The adhesive tape 40 may be disposed to the inner panel 10 along the tape-receiving groove 11 and around a periphery of the area requiring watertightness. Since the tape-receiving groove 11 is provided, the attachment of the adhesive tape 40 may be performed so that the adhesive tape 40 is received in the tape-receiving groove 11. Thus, the tape-receiving groove 11 may serve as a guide when the adhesive tape 40 is attached to the inner panel 10.

The adhesive tape 40 may include a butyl component.

The plastic film seal 30 may be provided between the inner panel 10 and the door trim 20 to prevent moisture from moving or migrating from the inner panel 10 toward the door trim 20.

The plastic film seal 30 may be attached to the inner panel 10 by means of the adhesive tape 40.

The plastic film seal 30 may be manufactured by vacuum molding. The plastic film seal 30 may be made into a shape conforming to the inner panel 10 by the vacuum molding. In other words, in a portion of the inner panel 10 protruding into a compartment of the vehicle, the plastic film seal 30 may be also configured to protrude into the compartment of the vehicle. This is intended to prevent a problem that, when the plastic film seal 30 is attached to the inner panel 10, the protruding portion of the inner panel 10 or a wiring W may cause the plastic film seal 30 to be wrinkled or the circumference of the plastic film seal 30 to not be attached to the inner panel 10. The plastic film seal 30 may be formed to have a three-dimensional (3D) shape inside a mold by the vacuum molding, and thus on the portion protruding from the inner panel 10 or a portion on which the cable W is located, the plastic film seal 30 may be formed into a convex shape by conforming such a protruding feature. Therefore, a phenomenon in which the plastic film seal 30 is wrinkled or a peripheral portion of the plastic film seal 30 is not attached to the inner panel 10 may be avoided or prevented.

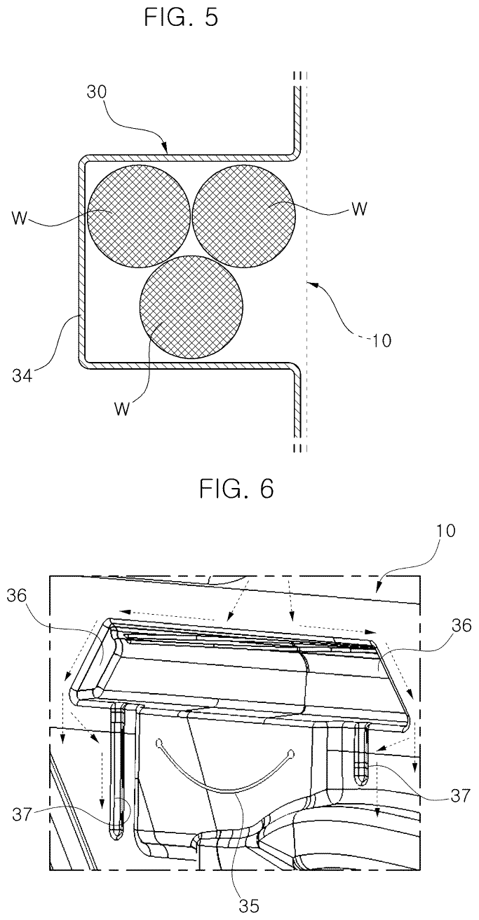

The plastic film seal 30 may be molded from a thermoplastic material, e.g., polyethylene (PE). When the plastic film seal 30 is manufactured by vacuum molding, the vacuum molding may be performed so that the surface of the plastic film seal 30 may be formed to have an embossed surface (see the enlarged view in the left bottom of FIG. 5). Since the surface of the plastic film seal 30 is embossed, when the plastic film seal 30 is stored, a phenomenon in which adjacent plastic film seals 30 are in close contact with each other and not detached from each other may be prevented. In addition, when the plastic film seal 30 is attached using the adhesive tape 40, the attachment force of the plastic film seal 30 to the adhesive tape 40 may be improved by the embossed surface.

The plastic film seal 30 may have an adhesion guide 31 protrusively formed along its periphery to receive the adhesive tape 40. The adhesion guide 31 may be configured to receive or accommodate a portion of the cross-section of the adhesive tape 40. The adhesion guide 31 may guide a worker to align the plastic film seal 30 with the adhesive tape 40 using the adhesion guide 31, thereby allowing the worker to easily attach the plastic film seal 30.

In addition, since the tape-receiving groove 11 is formed in the inner panel 10 and the adhesion guide 31 is formed along the tape-receiving groove 11, the adhesive tape 40 may be located in a space formed by the adhesion guide 31 and the tape-receiving groove 11 as illustrated in FIG. 4. In addition, the adhesive tape 40 may be formed into a closed curve within the plastic film seal 30.

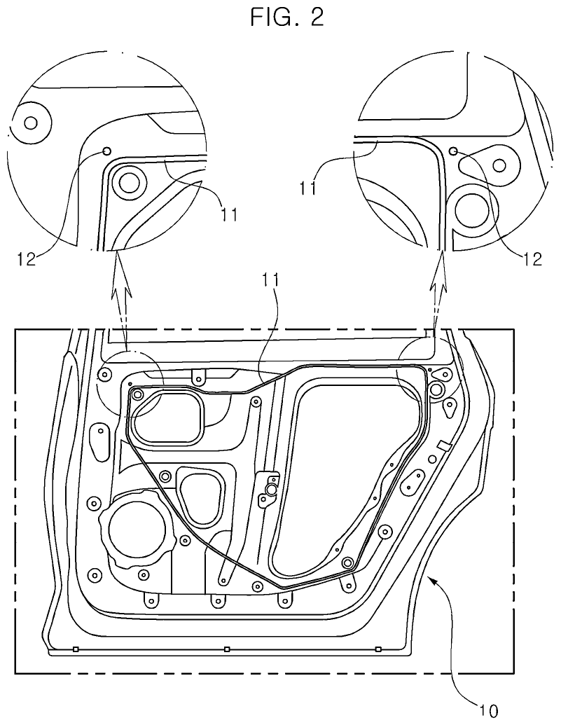

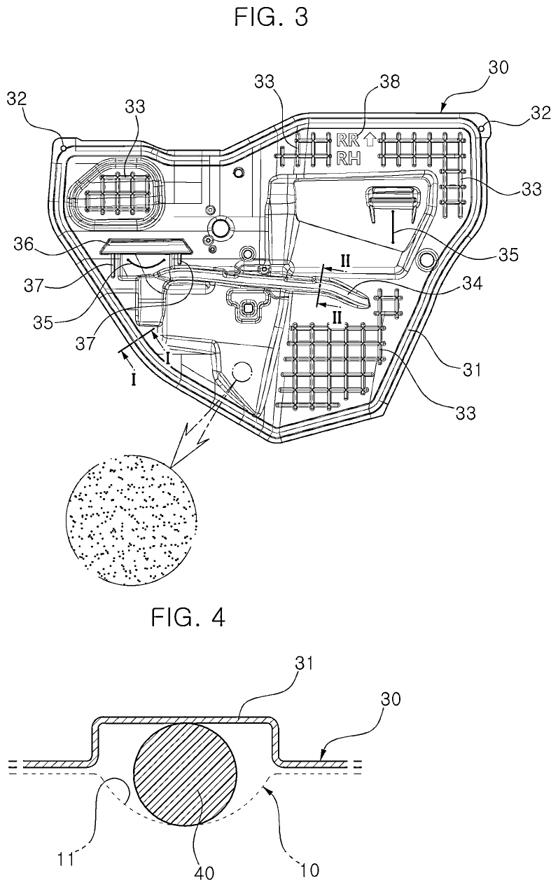

In order to easily limit the attachment position of the plastic film seal 30 to the inner panel 10, mounting reference protrusions 12 and mounting reference holes 32 may be correspondingly formed in the inner panel 10 and the plastic film seal 30. The mounting reference protrusions 12 may be provided on the inner panel 10 formed as a rigid body such as a metal plate and protrude from the surface of the inner panel 10, and the mounting reference holes 32 may be provided in the plastic film seal 30. The mounting reference protrusions 12 may be provided on the inner panel 10 to protrude into the vehicle. The mounting reference holes 32 may be provided in the plastic film seal 30 such that mounting reference protrusions 12 extend therethrough. In one embodiment, a plurality of mounting reference protrusions 12 may be provided on the inner panel 10, and a plurality of mounting reference holes 32 may be provided in the same number as the mounting reference protrusions 12. The mounting reference protrusions 12 may be provided on the top portions of the inner panel 10, and the mounting reference holes 32 may be provided on the top portions of the plastic film seal 30. In addition, as shown in FIGS. 2 and 3, the mounting reference protrusions 12 may be located outside the tape-receiving groove 11 in the inner panel 10, and the mounting reference holes 32 may be located outside the adhesion guide 31 in the plastic film seal 30. When the plastic film seal 30 is attached to the inner panel 10 so that the mounting reference protrusions 12 extend through the mounting reference holes 32, the plastic film seal 30 may be located in position even when no other portions may be aligned additionally.

Reinforcement ribs 33 may be provided to allow the plastic film seal 30 to maintain the 3D shape. In the plastic film seal, the reinforcement ribs 33 may be provided at predetermined positions and in predetermined areas. The reinforcement ribs 33 may be provided to protrude from the plastic film seal 30 in the form of a grid. Due to the grid structure, the strength of the soft plastic film seal 30 may be enhanced.

Referring to FIG. 5, the plastic film seal 30 may have a wiring receptacle 34 configured to receive or accommodate the wiring W provided on the door. The wiring receptacle 34 may be convex from the surface of the plastic film seal 30 toward the door trim 20 to receive the wiring W therein.

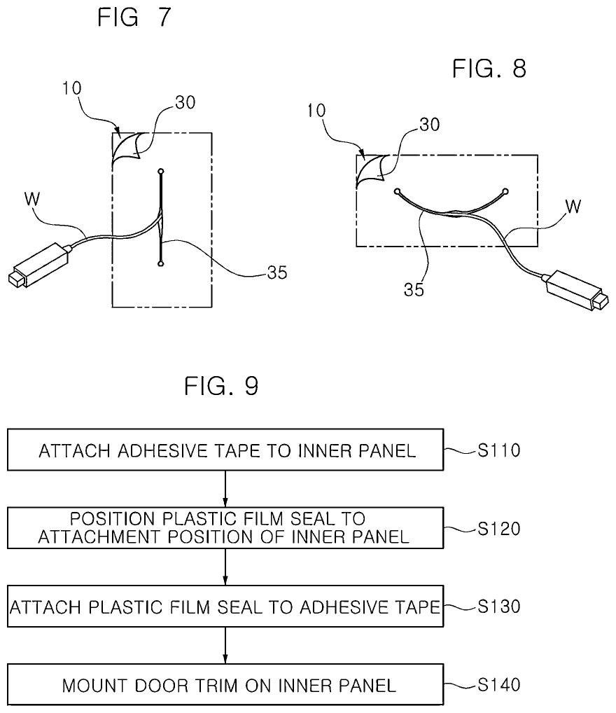

The plastic film seal 30 may be provided with a wiring slit 35 allowing the wiring W to extend through the plastic film seal 30. Since some wirings W provided on the vehicle door 100 may be required to be electrically connected to the door trim 20, the wiring slit 35 may be provided in the plastic film seal 30 such that the wiring W extends therethrough. FIGS. 7 and 8 respectively illustrate an example in which the wiring W extends through the plastic film seal 30 via the wiring slit 35.

The plastic film seal 30 may use a structure for guiding flow of moisture inevitably introduced between the plastic film seal 30 and the inner panel 10. For example, moisture may enter between the plastic film seal 30 and the inner panel 10 through an inner belt part of the inner panel 10. In order to guide moisture entering between the plastic film seal 30 and the inner panel 10 in this manner, the plastic film seal 30 may be provided with a first drain guide 36 and a second drain guide 37.

The first drain guide 36 may be provided on the plastic film seal 30 to protrude outward from the vehicle. In addition, the first drain guide 36 may be configured such that the width thereof increases in the downward direction so that moisture flows along the first drain guide 36 as shown in arrows.

The second drain guide 37 may be provided below the first drain guide 36. The second drain guide 37 may guide moisture that has bypassed the first drain guide 36 to flow to the lowermost end between the inner panel 10 and the plastic film seal 30 as shown in arrows.

The inner panel 10 may be provided with a drain hole (not shown) through which moisture that has moved to the lower portion through between the inner panel 10 and the plastic film seal 30 is discharged to the outside. In other words, the drain hole may be formed in a portion of the inner panel 10 adjacent to the lower end of the first drain guide 36, the lower end of a portion of the inner panel 10 surrounded by the plastic film seal 30, or the like so that the moisture is discharged from the vehicle door 100 through the drain hole.

The plastic film seal 30 may be provided with letterings 38 such as “RR, RH” on which a vehicle door in which the plastic film seal 30 is applied, a mounting direction of the plastic film seal 30, and the like are marked. For example, FIG. 3 illustrates the plastic film seal 30 used in a passenger side rear door. In addition, in FIG. 3, an arrow indicates that the top end in the figure may be also the top end of the door.

FIG. 9 is a flowchart illustrating a method of assembling the vehicle door including a plastic film seal according to an embodiment of the present disclosure.

The method of assembling a vehicle door 100 including a plastic film seal according to the present disclosure includes a tape attachment step S110 of attaching the adhesive tape 40 to the tape-receiving groove 11 provided in the inner panel 10, a plastic film seal positioning step S120 of positioning the plastic film seal 30 at a predetermined position of the inner panel 10, a plastic film seal attachment step S130 of attaching the plastic film seal 30 to the adhesive tape 40 by pressing the plastic film seal 30 along a portion to which the adhesive tape 40 is attached, and a trim mounting step S140 of mounting the door trim 20 on the inner panel 10.

The tape attachment step S110 includes attaching the adhesive tape 40 to the tape-receiving groove 11 provided in the inner panel 10. The tape-receiving groove 11 may be provided in the inner panel 10 in the form of a closed curve while being concave to a predetermined depth, and the adhesive tape 40 may be attached along the tape-receiving groove 11. Since the tape-receiving groove 11 is provided in the form of a closed curve, when the attachment of the adhesive tape 40 to the inner panel 10 is completed, the adhesive tape 40 attached to the inner panel 10 may be also in the form of a closed curve.

The plastic film seal positioning step S120 may include positioning the plastic film seal 30 at a predetermined position of the inner panel 10. Since the plastic film seal 30 includes a soft material and the periphery of the plastic film seal 30 is required to be attached to the inner panel 10, the plastic film seal 30 may be positioned on the inner panel 10.

In the plastic film seal positioning step S120, the plastic film seal 30 may be positioned using the mounting reference protrusions 12 and the mounting reference holes 32 provided in the inner panel 10 and the plastic film seal 30. In other words, the plastic film seal 30 may be positioned with respect to the inner panel 10 by fitting the mounting reference holes 32 provided in the plastic film seal 30 around the mounting reference protrusions 12 provided on the inner panel 10.

The plastic film seal attachment step S130 includes attaching the plastic film seal 30 to the adhesive tape 40 by pressing the plastic film seal 30 along a portion to which the adhesive tape 40 is attached. The surface of the plastic film seal 30 may be pressed along the periphery of the plastic film seal 30, i.e., the portion of the plastic film seal 30 in which the adhesion guide 31 is provided, so that the plastic film seal 30 and the adhesive tape 40 are attached to each other. In this manner, the periphery of the plastic film seal 30 may be attached to the inner panel 10, thereby forming a watertight seal between the inner panel 10 and the plastic film seal 30.

In addition, the wiring W extending through the plastic film seal 30 may be caused to extend through the plastic film seal 30 before the plastic film seal attachment step S130 is performed. Alternatively, in the plastic film seal attachment step S130, the periphery of the plastic film seal 30 may be adhered to the inner panel 10 while the wiring W is being caused to extend through the plastic film seal 30.

The trim mounting step S140 may include mounting the door trim 20 on the inner panel 10. As the door trim 20 is mounted on the inner panel 10, the inner panel 10 may be finished. As an example of the method of mounting the door trim 20 on the inner panel 10, the door trim 20 may be mounted on the inner panel 10 by fitting a pin provided on the inner surface of the door trim 20 into a fastening hole provided in the inner panel 10.

What is claimed is:

1. A vehicle door comprising:
an outer panel;
an inner panel provided inside of the outer panel;
a door trim attached to the inner panel and finishing the inner panel; and
a plastic film seal provided between the inner panel and the door trim.

2. The vehicle door of claim 1, wherein the plastic film seal is attached to the inner panel by an adhesive tape.

3. The vehicle door of claim 2, wherein the inner panel comprises a tape-receiving groove configured to receive the adhesive tape.

4. The vehicle door of claim 3, wherein the tape-receiving groove forms a closed curve surrounding a predetermined area on the inner panel.

5. The vehicle door of claim 2, wherein the plastic film seal comprises an adhesion guide configured to receive the adhesive tape.

6. The vehicle door of claim 5, wherein the adhesion guide forms a closed curve extending along a periphery of the plastic film seal.

7. The vehicle door of claim 1, wherein the inner panel comprises a mounting reference protrusion protruding into a compartment of a vehicle, and
the plastic film seal comprises a mounting reference hole allowing the mounting reference protrusion to penetrate therethrough.

8. The vehicle door of claim 1, wherein the plastic film seal comprises reinforcement ribs in a form of a grid.

9. The vehicle door of claim 8, wherein the reinforcement ribs are provided at a predetermined position and in a predetermined area on the plastic film seal.

10. The vehicle door of claim 1, wherein the plastic film seal comprises a wiring receptacle convex toward the door trim and configured to receive a wiring.

11. The vehicle door of claim 1, wherein the plastic film seal comprises a wiring slit allowing a wiring to extend therethrough.

12. The vehicle door of claim 1, wherein the plastic film seal comprises a first drain guide protruding toward an outside of a vehicle, with a width thereof increasing in a downward direction so that moisture flows by bypassing the first drain guide.

13. The vehicle door of claim 12, wherein the plastic film seal comprises a second drain guide provided below the first drain guide and configured to guide moisture to flow downward for discharge.

14. The vehicle door of claim 1, wherein the plastic film seal is made of polyethylene.

15. The vehicle door of claim 1, wherein the plastic film seal is formed by vacuum molding a plastic film.

16. The vehicle door of claim 1, wherein the plastic film seal is formed in a shape conforming to a shape of the inner panel.

17. The vehicle door of claim 1, wherein the plastic film seal comprises an embossed surface.

18. A method of assembling a vehicle door including a plastic film seal, the method comprising:
attaching an adhesive tape to a tape-receiving groove provided in an inner panel;
positioning a plastic film seal at a predetermined position of the inner panel;
attaching the plastic film seal to the adhesive tape by pressing the plastic film seal along a portion to which the adhesive tape is attached; and
mounting a door trim on the inner panel.

19. The method of claim 18, wherein, in positioning the plastic film seal,
the plastic film seal is positioned on the inner panel by aligning a mounting reference hole provided in the plastic film seal with a mounting reference protrusion provided on the inner panel.

20. A vehicle including a vehicle door of claim 1.
